(19) United States
(12) Patent Application Publication
(10) Pub. No.: US 2015/0149265 A1
(43) Pub. Date: May 28, 2015

(54) CONTROLLED PARKING OF AUTONOMOUS VEHICLES

(71) Applicant: GM GLOBAL TECHNOLOGY OPERATIONS LLC, Detroit, MI (US)

(72) Inventors: FRED W. HUNTZICKER, ANN ARBOR, MI (US); PAUL R. WILLIAMS, NORTHVILLE, MI (US)

(73) Assignee: GM GLOBAL TECHNOLOGY OPERATIONS LLC, Detroit, MI (US)

(21) Appl. No.: 14/091,796

(22) Filed: Nov. 27, 2013

(51) Int. Cl. B60W 30/06; G06Q 20/14; G06Q 50/30; G08G 1/14; B60W 10/20

(52) U.S. Cl. CPC B60W 30/06; G08G 1/141; B60W 10/20; G06Q 50/30; G06Q 20/145
USPC 705/13; 701/23; 701/1

(57) ABSTRACT

Systems and methods for controlled parking of autonomous vehicles are provided. In one embodiment, a method includes sending a request from a vehicle to park within a parking area controlled by a parking control system using a bi-directional trust system employing a digital authentication certificate, receiving at the vehicle a parking space assignment from the parking control system indicating an assigned parking space within the parking area using the bi-directional trust system, and autonomously controlling the vehicle to drive the vehicle to the assigned parking space within the parking area.

### TECHNICAL FIELD

The technical field generally relates to vehicles, and more particularly relates to systems and methods for controlled parking of autonomous vehicles.

### BACKGROUND

Parking a vehicle between two other vehicles or in a multi-vehicle lot is often a difficult task for a driver. Further, with increased urban congestion, the space available for vehicle parking is at a premium.

Autonomous and semi-autonomous vehicle systems aid the driver in performing certain tasks. Such systems either guide the driver in steering the vehicle through its intended trajectory path or increase/decrease power steering efforts when the driver of the vehicle has deviated from the intended trajectory path.

However, the prior art is deficient of a comprehensive system or method that utilizes the functionality of autonomous vehicles to assist in vehicle parking. The prior art is further deficient of such systems and methods that optimize vehicle parking to minimize open space in parking areas.

In view of the foregoing, it is desirable to provide systems and methods to assist drivers in parking vehicles. In addition, it is desirable to provide systems and methods to increase parking density in a given parking area. Furthermore, other desirable features and characteristics of the present invention will become apparent from the subsequent detailed description and the appended claims, taken in conjunction with the accompanying drawings and the foregoing technical field and background.

### SUMMARY

A system is provided in connection with an autonomous vehicle. In one embodiment, the system includes a control circuit configured to receive a request from a vehicle to park within a parking area controlled by the system using a bi-directional trust system employing a digital authentication certificate, a database configured to store the request and to store a configuration of the parking area, and a software module configured to determine an optimized parking location for the vehicle within the parking area based on the configuration of the parking area. The control circuit is further configured to send to the vehicle a parking space assignment indicating an assigned parking space within the parking area using the bi-directional trust system.

A method is provided for operating an autonomous vehicle. In one embodiment, the method includes sending a request from a vehicle to park within a parking area controlled by a parking control system using a bi-directional trust system employing a digital authentication certificate, receiving at the vehicle a parking space assignment from the parking control system indicating an assigned parking space within the parking area using the bi-directional trust system, and autonomously controlling the vehicle to drive the vehicle to the assigned parking space within the parking area.

In yet another embodiment, a vehicle includes a telematics unit configured to send a request from the vehicle to park within a parking area controlled by a parking control system using a bi-directional trust system employing a digital authentication certificate, the telematics unit further configured to receive at the vehicle a parking space assignment from the parking control system indicating an assigned parking space within the parking area using the bi-directional trust system. The vehicle further includes an autonomous vehicle control system configured to control the vehicle to drive the vehicle to the assigned parking space within the parking area.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

The exemplary embodiments will hereinafter be described in conjunction with the following drawing figures, wherein like numerals denote like elements, and wherein:

FIG. 1 illustrates an operating environment in accordance with an exemplary embodiment of the present disclosure;

FIG. 2 illustrates an autonomous vehicle in accordance with an exemplary embodiment of the present disclosure;

FIG. 3 illustrates a method provided in connection with the autonomous vehicle illustrated in FIG. 2;

FIG. 4 illustrates a parking control system in accordance with an exemplary embodiment of the present disclosure;

FIG. 5 illustrates a method provided in connection with the parking control system illustrated in FIG. 4; and

FIG. 6 illustrates a parking payment system in accordance with an exemplary embodiment of the present disclosure.

### DETAILED DESCRIPTION

The following detailed description is merely exemplary in nature and is not intended to limit the application and uses of the disclosure. Furthermore, there is no intention to be bound by any expressed or implied theory presented in the preceding technical field, background, brief summary or the following detailed description.

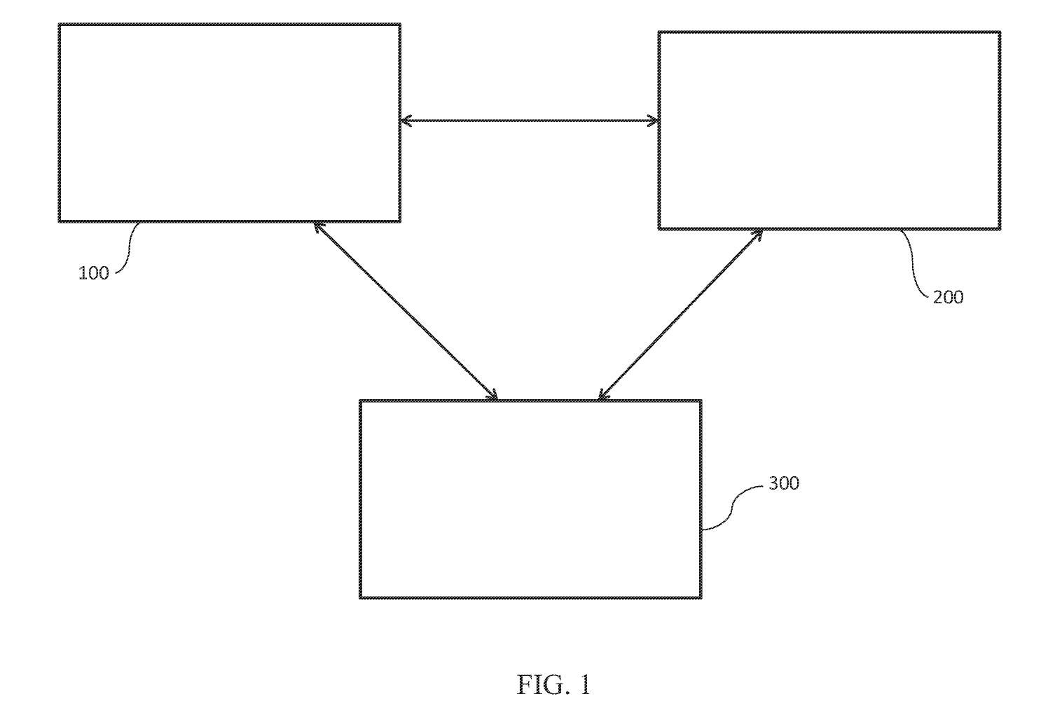

FIG. 1 illustrates an exemplary operating environment including a plurality of inter-operable systems in accordance with the present disclosure, and on which a plurality of methods in accordance with the present disclosure may be implemented. The operating environment includes at least one autonomous vehicle 100. As used herein, the term “autonomous vehicle” refers to any vehicle having the capability to implement one or more driving controls (forward or reverse movement, steering, braking, etc.) without direct input from a driver. The operating environment further includes a parking control system 200. Parking control system 200 is in operable electronic communication with the vehicle 100 through one or more electronic transmission means, including for example wireless radio communication means. In some embodiments, the electronic transmission means may include the use of a secure communication and bi-directional trust system employing the use of digital authentication certificates, as will be discussed in greater detail below. Parking control system 200 broadly functions to provide one or more parking instructions to vehicle 100 to direct the autonomous controls of vehicle 100 to park the vehicle 100 in an optimized configuration in a given parking area, to provide one or more instructions to other vehicles in the given parking area to facilitate the parking of vehicle 100, and to facilitate the staging of vehicles, including vehicle 100, to allow vehicle 100 to exit the given parking area at a desired time.

In some embodiments, the operating environment illustrated in FIG. 1 may optionally include a parking payment system 300. Parking payment system 300 is in operable electronic communication with the vehicle 100 and the parking control system 200 through one or more electronic transmission means, including for example wireless radio communication means with bi-directional trust system. Parking payment system 300 broadly functions to accept payment from a vehicle operator for the service provided by the parking control system 200 to park the operator's vehicle 100.

Various exemplary implementations of the autonomous vehicle 100, the parking control system 200, and the parking payment system 300 are described in detail below.

### Autonomous Vehicle

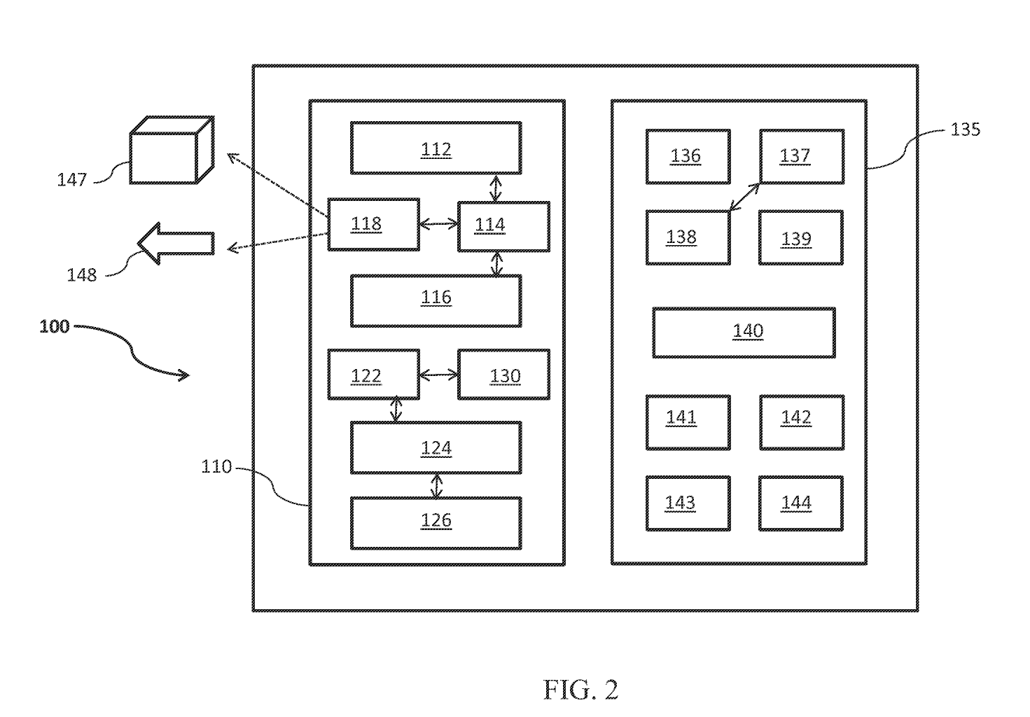

There is shown in FIG. 2 an embodiment of an autonomous vehicle 100. The vehicle 100 includes at least an autonomous operating system 110 for assisting in parking the vehicle 100. The autonomous operating system 110 includes a steering module 112 and a controller 114 for controlling steerable wheels 116 of the vehicle 100. The operating system 110 further includes a drive module 122 and a controller 124 for controlling transmission 126 of the vehicle 100. The steering module 112 may be an electronic module or similar device that is capable of turning the steerable wheels 116 without a driver's steering demand via a steering wheel of the vehicle. The controller 114 provides control input signals to the steering module 112, such as a conventional electronic power steering module, for controlling the turning of the steerable wheels during a parking maneuver. The controller 114 may be separate from the steering module 112 or may be integrated within the steering module 112 as a single unit. The drive module 122 may be an electronic module or similar device that is capable of engaging transmission 126 in either the forward or reverse direction without a driver's demand via a transmission shift mechanism of the vehicle 100. The controller 124 provides control input signals to the drive module 122, such as a conventional electronic drive module, for controlling the forward and reverse movements of the vehicle 100 during a parking maneuver. The controller 124 may be separate from the drive module 122 or may be integrated within the drive module 122 as a single unit. It will be appreciated that the drive module 122 may operate in connection with an automated braking system 130 of the vehicle 100 for further controlling the forward and reverse movements of the vehicle 100.

The autonomous operating system 110 further includes a sensing device 118 for detecting objects 147 and position marking indicators 148 proximate to the driven vehicle. As used herein, the term “objects” refers to any three-dimensional object that may be an obstruction in the path of the vehicle 100. As further used herein, the term “position marking indicator” refers to any symbology used to provide a reference position for the vehicle 100, such as lane lines, arrows, numbers, and the like. The sensing device 118 detects the presence and non-presence of objects 147 and position marking indicators 148 laterally from the vehicle for determining target parking space between objects 147 or in reference to position marking indicators 148. The sensing device 118 may include a radar-based sensing device, an ultrasonic-based sensing device, an imaging-based sensing device, or similar device capable of providing a signal characterizing the available space between the objects 147 or with reference to position marking indicators 148. The sensing device 118 is in communication with the controller 114 for providing signals to the controller 114. The sensing device 118 may be capable of determining the distance between the respective objects 147 or position marking indicators 148 and communicating the determined distance to the controller 114, or the sensing device 118 may provide signals to the controller 114 to be used by the controller 114 to determine the distance of the spacing between the objects 147 or position marking indicators 148.

A routine for determining whether a vehicle may be parked in an available parking space is described in a co-pending application having a Ser. No. 12/107,130, filed on Apr. 22, 2008, which is incorporated by reference in its entirety. The routine determines a first minimum length for parking the vehicle based on available parking space. Another routine for determining a path planning trajectory for parallel parking the vehicle based on the available parking space is described in co-pending application having a Ser. No. 12/367,778 filed on Feb. 9, 2009, which is incorporated by reference in its entirety. It should be understood that an embodiment as described herein may be utilized with other methods which determine the available parking space in addition to the method which determines the intended trajectory for parallel parking the vehicle 100. It should further be appreciated that the parking routine may be based on any number of parking configurations. An exemplary parking configuration includes a parallel parking arrangement, wherein vehicles are parked parallel to one another in rows. Another exemplary parking configuration includes the so-called “double parking” configurations, wherein vehicles may be parked immediately adjacent to one another to increase the use of available parking space. Other suitable parking configurations may be known to those having ordinary skill in the art.

Furthermore, vehicle 100 includes a telematics unit 135. Operatively coupled to the telematics unit 135 is a network connection or vehicle bus 136. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 136 enables the vehicle 100 to send and receive signals from the telematics unit 135 to various units of equipment and systems both outside the vehicle 100 and within the vehicle 100 to perform various functions, such as communicating with a parking control system 200 using a bi-directional trust system with digital authentication certificates as will be described in greater detail below.

The telematics unit 135 generally includes an electronic processing device 137 operatively coupled to one or more types of electronic memory 138, a cellular chipset/component 139, a wireless modem 140, a navigation unit containing a location detection (e.g., global positioning system (GPS)) chipset/component 141, a real-time clock (RTC) 142, a short-range wireless communication network 143 (e.g., a Bluetooth® unit), and/or a dual antenna 144.

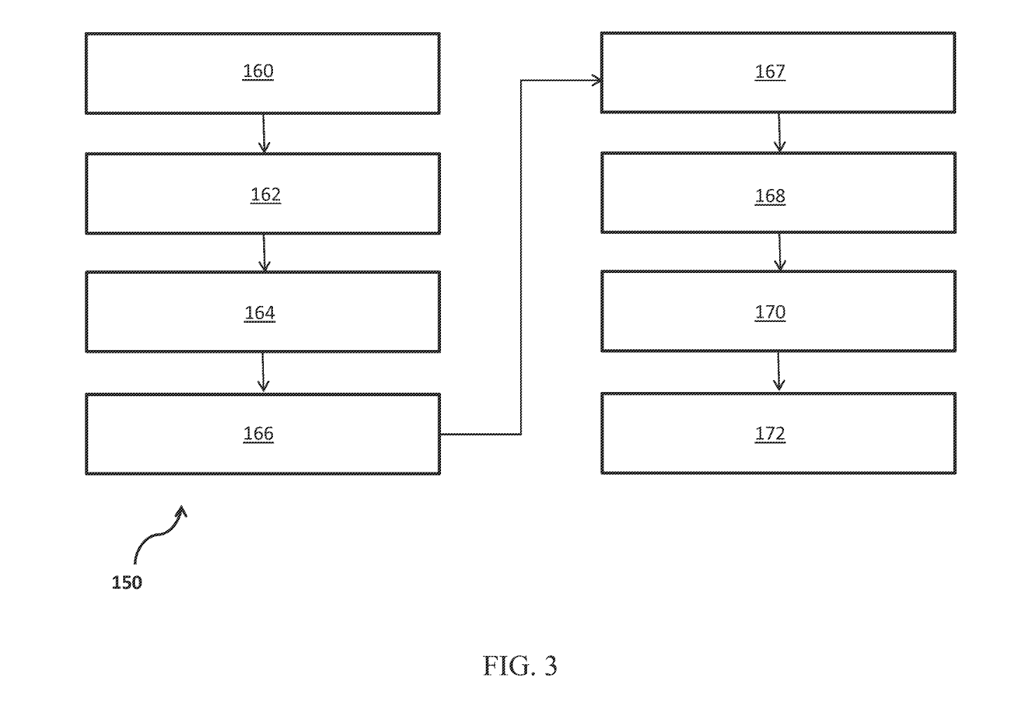

FIG. 3 illustrates a flowchart of a method 150 for initiating a parking routine. In step 160, the routine is initiated and the vehicle 100 monitors for an available parking space, for example as may be provided to it by the parking control system 200, described in greater detail below. The monitoring may be manually actuated by the driver of the vehicle 100 enabling a routine that actuates the sensing devices to monitor for an available parking space. In step 162, target parking space is provided from the parking control system 200 to the vehicle 100. Step 162 may also include the control system 200 moving other vehicles (that is, sending other autonomous vehicles instructions for movement) in the parking area to make room or to make a path for the vehicle 100 to access the available parking space. In some embodiments, the step 162 may further include the control system 200 moving other vehicles in the parking area to open the parking space, thereby making it available for vehicle 100.

In step 164, a path planning routine is initiated for generating a planned path for parking the vehicle, in coordination with the sensed position of the objects or the position marking indicators related to the indicated parking space, if any. In step 166, a comparison is made with respect to the vehicle 100 location and the parking space. If, based on the presence of one or more objects or the position of a position marking indicator the vehicle 100 determines that the parking routine is not feasible, a notification may be provided to the driver of the vehicle indicating the infeasibility of not being able to perform the parking routine. In addition to step 162, the control system 200 may move other vehicles in the parking area in step 166 to make way for the entry of vehicle 100 in response to determining (or receiving a determination) that the parking routine is not feasible. If the determination is made that the location of the vehicle is in a position such that parking is feasible, then the routine proceeds to step 167.

In step 168, once feasibility is confirmed, the parking strategy is executed. In step 170, the steering wheel angle, the vehicle speed, and the vehicle braking are autonomously controlled for parallel parking the vehicle. In step 172, once the vehicle is parked at its final park position, the routine is exited.

It should be understood that for the embodiments described herein, that the terms clockwise steering maneuver and counterclockwise steering maneuver are designated terms for vehicles that utilize left side steering systems. Without deviating from the scope of the invention, it is understood that the invention is meant to include those vehicle systems that use right side steering system and that the steering maneuver designations (e.g., clockwise and counterclockwise) would be reversed under such circumstances.

It should also be understood that the determination of the designation region for initiating parking may be used with semi-autonomous parking routines where some input control is required by the driver or for manual parking routines where the driver is provided a planned parking path and must follow the planned route accordingly. In each of the instances, the designated region may be used to notify the driver whether the planned parking path as determined may be initiated.

### Parking Control System

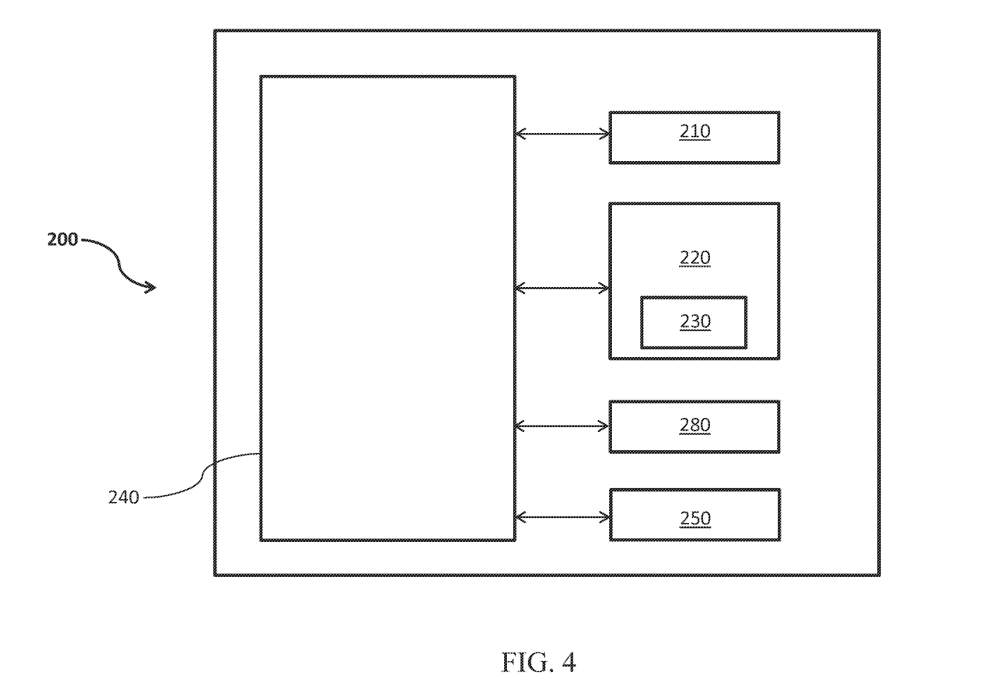

FIG. 4 is a high-level diagram illustrating an exemplary configuration of a parking control system 200. As initially noted above, parking control system 200 is on operable electronic communication with vehicle 100 using a bi-directional trust system with digital authentication certificates to provide vehicle 100 with instructions for parking within a designated area, such as a parking lot. As used herein, the term bi-directional trust system refers to any digital communication protocol, whether encrypted or unencrypted, that employs the use of a digital authentication certificate that sets forth permissions granted to the system 200. As used herein, the term digital authentication certificate refers to any data file that includes information related to a particular vehicle, including vehicle specifications, and further includes one or more permissions regarding the autonomous control of the vehicle, such as an authorization to sending autonomous control instructions to the vehicle under certain conditions, such as certain dates, certain times, in certain locations, etc. Parking control system 200 functions to direct one or more autonomous vehicles 100 to park in a configuration such that parking space is optimized (i.e., empty space is minimize), while still leaving enough room for the vehicles 100 to traverse in an out of the parking area. In this manner, parking control system 200 broadly functions to provide one or more parking instructions to vehicle 100 to direct the autonomous controls of vehicle 100 to park the vehicle 100 in an optimized configuration in a given parking area, to provide one or more instructions to other vehicles in the given parking area to facilitate the parking of vehicle 100, and to facilitate the staging of vehicles, including vehicle 100, to allow vehicle 100 to exit the given parking area at a desired time. The optimized configuration is based on the given geometric confines of the parking lot under control of the system 200. Thus, system 200 optimizes the parking of cars based at least in part on an algorithm that optimizes the number an configuration of parking spaces in a given geometric area.

In one arrangement, parking control system 200 may be a computer such as a personal computer or a server. In another arrangement, parking control system 200 may be a plurality of computers in communication with one another, though it should be understood that parking control system 200 may be practically any computing device capable of embodying the systems and/or methods described herein.

Parking control system 200 includes a control circuit 240 which is operatively connected to various hardware and software components that serve to enable operation of the parking control system 200. The control circuit 240 is operatively connected to a processor 210 and a memory 220, such as a non-transitory storage medium. Preferably, memory 220 is accessible by processor 210, thereby enabling processor 210 to receive and execute instructions stored on memory 220.

One or more software modules 230 are encoded in memory 220. The software modules 230 may include a software program or set of instructions executed in processor 210. Preferably, the software modules 230 make up a parking control application that is executed by processor 210. During execution of the software modules 230, the processor 210 configures the control circuit 240 to manage and optimize the shared usage of a set of parking spaces, as will be described in greater detail below. It should be noted that while FIG. 4 depicts memory 220 oriented on control circuit 240, in an alternate arrangement, memory 220 may be practically any storage medium (such as a hard disk drive, flash memory, etc.) that is operatively connected to the control circuit 240, even if not oriented on control circuit 240 as depicted in FIG. 4.

Also connected to control circuit 240 is a database 280. Database 280 receives, transmits, and stores data and/or information received by and/or pertaining to the operation of the parking control system 200, as will be described in greater detail below. Database 280 is preferably a computing device (such as a personal computer or server) and/or several connected computing devices with a storage medium that is capable of maintaining the data/information generated and/or received by parking control system 200. In an alternate arrangement, database 280 may be a data storage device such as a hard disk, or an array of storage devices (e.g., RAID). It should be noted that while FIG. 4 depicts database 280 as a being a stand-alone element that is communicatively connected to control circuit 240, in other arrangements database 280 may be oriented on control circuit 240, such as being incorporated into memory 220.

A communication interface 250 is also operatively connected to control circuit 240. Communication interface 250 may be any interface that enables communication between the control circuit 240 and external devices, machines and/or elements, such as the telematics unit 135 of one or more vehicles 100. Preferably, communication interface 250 is a network interface controller such as an Ethernet or wireless (802.11) network adapter, thought it should be understood that communication interface 250 may be practically any interface that enables communication, such as wireless electronic communication, to/from the control circuit 240. The communication interface enables a secure, bi-directional trust system based on digital authentication certificates that grant the system 200 permission to move the autonomous vehicle 100 (and other autonomous vehicles) while the owner thereof is not present at the vehicle. In some embodiments, the digital authentication certificate for vehicle 100 may be sent from vehicle 100, at the initiation of the owner thereof, to the system 200, granting the system 200 permission to move the vehicle 100 using the communication interface 100. The digital authentication certificate may be store in the memory 220 for an indefinite period of time, or for a given period of time as designated by the owner of the vehicle, for example one or more hours, one or more days, one or more weeks, etc. Communication from the vehicle 100 to the interface 250 may also revoke the certificate, thereby denying the system 200 permission to direct autonomous movement of vehicle 100.

At various points during the operation of parking control system 200, control circuit 240 may communicate with the telematics unit 135 one or more vehicles 100. The telematics unit 135 transmits and/or receives data to/from the control circuit 240, as will be described in greater detail below.

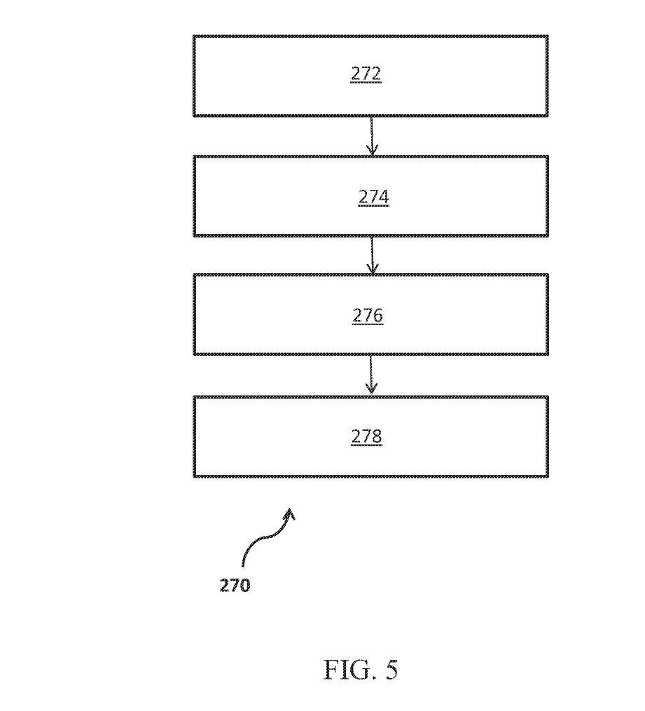

FIG. 5 illustrates a method 270 for operating parking control system 200. At step 272, in operation, a vehicle 100 initiates a request, via telematics unit 135, to the parking control system 200, such as through its communications interface 250, for parking within an area controlled by parking control system 200. In some embodiments, vehicle 200 may transmit vehicle information along with the request, such as vehicle type, vehicle dimensions, and the like. In other embodiments, the vehicle's information may be stored in memory 220 of system 200 by a previous transmission thereto of a digital authentication certificate, which is still active. Based on the request, and optionally the vehicle information, the parking control system 200 determines, at step 274, an optimal parking arrangement using an optimization engine (e.g., code such as an optimization module executing on a machine). This determination is achieved by further analyzing the parking area configuration, any vehicles that may already be parked therein, remaining space available, and the like, in conjunction with various other parking requests received by parking control system 200 from other vehicles 100. In doing so, the parking control system 200 may determine how to most optimally assign parking spaces that are available. In this manner, the parking control system 200 may include an optimization program as a part of modules 230 for determining an optimal parking configuration. The optimization program may be configured to accept a given parking area geometry, and optimize a parking arrangement based on the number of vehicles therein, the size of vehicles therein, a desired vehicle exit time (if known), and a desired parking arrangement (for example, parallel, double-parking, etc.).

At step 276, having optimized the parking arrangement, the parking control system 200 assigns a parking destination to the vehicle 100 based on the optimal parking arrangement. Additionally, as referenced above, under certain circumstances the parking control system 200 may assign parking destinations to several vehicles 100 as a result of the optimal parking arrangement. For example, as initially noted above, the parking control system may initiate communications to other vehicles in the parking area to execute intermediate movements to facility the entry and/or parking of vehicle 100. Intermediate movements of vehicles, including vehicle 100, may further by directed by system 200 to facilitate the staging of vehicles based on a known exit time of the vehicle, which may be on-demand (i.e., the user requests exit of the vehicle) or at a pre-scheduled time. Assignment may be provided via a communication form the parking control system 200, i.e., the communications interface 250 thereof, to the telematics unit of the vehicle 100. As previously discussed, the vehicle 100 is capable of recognizing, and moving autonomously with reference to, one or more objects 147 and one or more position indicating markers 148. Thus, in some embodiments, step 276 includes providing information regarding the current position of one or more other vehicles in the parking area and the position of the assigned parking space for the vehicle 100 with reference to one or more position indicating markers 148. In alternative embodiments, the assignment may be provided with reference to a coordinate system, such as GPS latitude/longitude coordinates.

Then, at step 278, the parking control system 200 routes or otherwise directs the vehicle 100 to the assigned parking space. In one arrangement, the parking control system 200 calculates a set of driving directions (such as turn-by-turn directions) and/or a route map based on the vehicle's (100) current location. This set of directions/map may further include specific instructions and/or directions that are unique to a particular parking area, such as a particular parking lot. For example, in the case of a large parking lot or structure which has multiple entrances, the parking management application, based on the vehicle's (100) current location and the exact location of the assigned space within the lot, may direct the vehicle 100 to the best entrance to use based on the various respective locations and other related factors (e.g., congestion in certain areas of the parking lot). These directions, maps, etc. may then be transmitted and/or otherwise conveyed to the appropriate vehicle 100 through the aforementioned communication means.

Additionally, in certain arrangements, the parking control system 200 may provide additional information and/or instructions that pertain to the specifics of the assigned parking space (e.g., that the vehicle 100 must back-in his/her vehicle). All of the referenced information (directions, route map, instructions, etc.) may be made available to the autonomous operating system 110 of the vehicle 100.

Thereafter, at step 280, the autonomous operating system 110 of the vehicle 100 may direct the vehicle 100 to the assigned parking space using the sensing device 118 to determine the position of one or more objects 147 and/or one or more position indicating markers 148, optionally in conjunction with the GPS component 141 of the telematics unit 135, to safely direct the vehicle 100, using steering module 112 and drive module 122, toward the assigned parking location.

### Parking Payment System

As will be appreciated, it is often required to provide some form of payment in order to park in a parking lot, such as a public or private parking facility in a congested urban area. Thus, in some embodiments, it may be desirable to provide a parking payment system 300 in operable electronic communication with the vehicle 100 and the parking control system 200. The parking payment system may operate in conjunction with the above-noted digital authentication certificates which, in addition to providing permission for vehicle movement, may provide information regarding payment for the parking services provided.

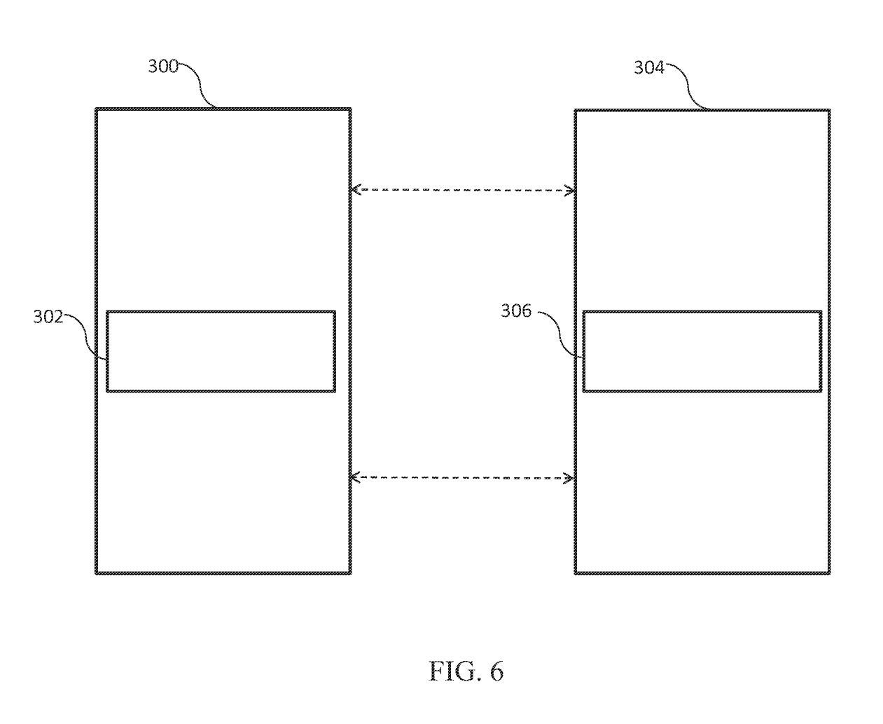

In one embodiment, as shown in FIG. 6, the parking payment system 300 includes a transponder 302 that communicates with a near field communication device (NFC) 304, which may be in the possession of the vehicle 100 operator or may be associated with the vehicle 100 itself. NFC device 304 enables a radio connection to be established by means of a NFC transmission technique. An electronic data memory 306, on which payment information is stored, is associated with the NFC device 304. The data memory 306 may be integrated in the NFC device 304. For example, information on a pre-paid credit balance or data to identify the owner of the vehicle 100 may be stored in the electronic data memory 306.

In operation, the NFC device 304 is brought into the receiving range of the transponder 302. The NFC device 304 is supplied with current by the transponder 304 and read out via a wireless data connection 305. The payment information stored in the electronic data memory 306 is thereby read out during the payment process. The payment is confirmed by the user of the vehicle 100, for example, by pressing a button associated with the payment system 100.

In other embodiments, payment may be made by a suitable communication through the telematics unit 135 of the vehicle 100. For example, payment information could be provided directly to the parking payment system 300, which is associated with the parking control system 200, upon the initial request made for parking therethrough. The telematics may store information regarding a payment account of the vehicle operator provided for such purpose. Alternatively, as noted above, authorization for payment, or pre-payment information, may be provided by way of the digital authentication certificates provided through the bi-directional trust system between vehicle 100 and parking system 200 (and payment system 300 thereof).

While exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes may be made in the function and arrangement of elements without departing from the scope of the disclosure as set forth in the appended claims and the legal equivalents thereof.

What is claimed is:

1. A method, comprising:
sending a request from a vehicle to park within a parking area controlled by a parking control system using a bi-directional trust system employing a digital authentication certificate;
receiving at the vehicle a parking space assignment from the parking control system indicating an assigned parking space within the parking area using the bi-directional trust system; and
autonomously controlling the vehicle to drive the vehicle to the assigned parking space within the parking area.

2. The method of claim 1, wherein sending the request comprises sending a request using a telematics unit of the vehicle.

3. The method of claim 2, wherein receiving the parking space assignment comprises receiving the parking space assignment at the telematics unit.

4. The method of claim 1, wherein sending the request comprises sending vehicle information.

5. The method of claim 1, wherein autonomously controlling the vehicle comprises autonomously operating a steering module and a drive module of the vehicle.

6. The method of claim 1, wherein autonomously controlling the vehicle comprises sensing an object or a position marking indicator outside of the vehicle.

7. The method of claim 7, further comprising sending payment information to a parking payment system associated with the parking control system.

8. A system, comprising:
a control circuit configured to receive a request from a vehicle to park within a parking area controlled by the system using a bi-directional trust system employing a digital authentication certificate;
a database configured to store the request and to store a configuration of the parking area and the digital authentication certificate; and
a software module configured to determine an optimized parking location for the vehicle within the parking area based on the configuration of the parking area;
the control circuit further configured to send to the vehicle a parking space assignment indicating an assigned parking space within the parking area using the bi-directional trust system.

9. The system of claim 8, wherein the control circuit comprises an operable electronic connection to a communications interface for receiving the request from a telematics unit of the vehicle.

10. The system of claim 8, wherein the control circuit is further configured to receive vehicle information from the vehicle and wherein the database is further configured to store the vehicle information.

11. The system of claim 10, wherein the software module is further configured to optimize vehicle parking within the parking area based at least in part on a geometric configuration of the parking area.

12. The system of claim 8, wherein the control circuit is further configured to send directions to the assigned parking space.

13. The system of claim 12, wherein the control circuit is further configured to send object or position marking indicator information to the vehicle.

14. The system of claim 12, further comprising a parking payment system configured to receive payment information from the vehicle.

15. A vehicle, comprising:
a telematics unit configured to send a request from the vehicle to park within a parking area controlled by a parking control system using a bi-directional trust system employing a digital authentication certificate;
the telematics unit further configured to receive at the vehicle a parking space assignment from the parking control system indicating an assigned parking space within the parking area using the bi-directional trust system; and
an autonomous vehicle control system configured to controlling the vehicle to drive the vehicle to the assigned parking space within the parking area.

16. The vehicle of claim 15, wherein the telematics unit is further configured to send payment information to a parking payment system associated with the parking control system.

17. The vehicle of claim 15, wherein the telematics unit is further configured to send vehicle information.

18. The vehicle of claim 15, wherein the autonomous vehicle control system comprises a steering module and a drive module.

19. The vehicle of claim 18, further comprising a sensing device for sensing an object or a position marking indicator outside of the vehicle.

20. The vehicle of claim 19, wherein the steering module, the drive module, and the sensing device cooperate to enable autonomous movement of the vehicle.
